(19) United States
(12) Patent Application Publication
(10) Pub. No.: US 2009/0039795 A1
(43) Pub. Date: Feb. 12, 2009

(54) DISCHARGE LAMP LIGHTING APPARATUS

(75) Inventor: Toru ASHIKAGA, Niiza-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sanken Electric Co., Ltd., Niiza-shi (JP)

(21) Appl. No.: 12/172,523

(22) Filed: Jul. 14, 2008

(30) Foreign Application Priority Data
Aug. 8, 2007 (JP) 2007-206641

(51) Int. Cl. H05B 37/02

(52) U.S. Cl. 315/209 R

(57) ABSTRACT

A discharge lamp lighting apparatus includes a plurality of discharge lamps 1a to 1d, an alternating voltage generator 10 to convert a DC voltage into an alternating voltage, and a transformer T1 having a primary winding P1 and a plurality of secondary windings S1 and S2. The primary winding is connected to an output terminal of the alternating voltage generator. The discharge lamps and secondary windings are connected in series to form a closed loop Lc1.

### BACKGROUND OF THE INVENTION

1. Field of the Invention

The present invention relates to a discharge lamp lighting apparatus for lighting discharge lamps such as cold cathode fluorescent lamps (CCFLs), external electrode fluorescent lamps (EEFLs), and other fluorescent lamps.

2. Description of Related Art

Generally, the CCFL turns on when applied with a voltage of several hundreds to one thousand and several hundreds of volts at a frequency of several tens of kilohertz. The EEFL is basically the same as the CCFL except the electrode structure thereof. A light emitting principle of the EEFL is also the same as that of the CCFL, and therefore, an inverter used to turn on the EEFL is the same in principle as that used to turn on the CCFL. Discharge lamps handled by below-mentioned discharge lamp lighting apparatuses are, for example, CCFLs.

A discharge lamp lighting apparatus includes-an inverter and a discharge lamp. The inverter has an alternating voltage generator to convert a DC voltage from a DC power source into an alternating voltage having a converted frequency. The alternating voltage is converted by a voltage converter into one having a required voltage value. The discharge lamp has a negative resistance characteristic, and therefore, is connected in series with an element having a positive resistance characteristic, such as a capacitor and an inductor, to provide a total impedance of positive resistance characteristic. The capacitor connected to the discharge lamp is called a ballast capacitor.

There is a ballast circuit that positively uses, as a ballast element, a leakage inductance of a transformer. This circuit generates a high voltage to turn on a discharge lamp, and once the discharge lamp turns on, lowers the voltage of the transformer to a level for sustaining the lit-upstate of the discharge lamp. There is no need for this circuit to always supply the high voltage. This is advantageous in terms of parts reliability, noise reduction, and safety. If the ballast element is a capacitor, there is always a voltage applied to the capacitor, and therefore, a high voltage is always needed.

The brightness of a discharge lamp is influenced by many factors. Among them, a current value passed through the discharge lamp greatly influences the brightness of the discharge lamp. If there are a plurality of discharge lamps to be lit up and if currents passed through the discharge lamps are equal to one another, the discharge lamps will each provide an equal brightness. It is preferable, therefore, to pass equal currents or balanced currents to a plurality of discharge lamps to be turned on.

A multiple-lamp lighting circuit including ballast elements such as capacitors connected in series with discharge lamps can continuously apply a lighting start voltage to each discharge lamp without regard to whether the other discharge lamps are ON or OFF. A multiple-lamp lighting circuit employing leakage transformers can achieve the same by arranging leakage inductances serving as ballast elements for discharge lamps, respectively. Namely, the multiple-lamp lighting circuit utilizing leakage inductances as ballast elements needs as many transformers as discharge lamps. To reduce the number of leakage transformers, each transformer must be provided with a plurality of secondary windings. For example, providing each transformer with two secondary windings can halve the number of transformers of the multiple-lamp lighting circuit.

Variations in currents passed through discharge lamps will be explained. A current passed through a discharge lamp to be lit up is dependent on an impedance of the discharge lamp, a change in the impedance due to temperatures, the capacitance of a capacitor connected to the discharge lamp, and the like. Due to them, currents passed through a plurality of discharge lamps differ from one to another.

FIG. 1 is a circuit diagram showing a discharge lamp lighting apparatus according to related art 1. Four discharge lamps 1a to 1d are connected in series with four capacitors C1 to C4, respectively. An inverter 3 has an alternating voltage generator 10 and a voltage converter 11. The alternating voltage generator 10 converts a DC voltage Vin from a DC power source into an alternating voltage of a converted frequency and the voltage converter 11 converts the alternating voltage into one having a voltage value necessary for turning on the four discharge lamps 1a to 1d.

FIG. 2 is a circuit diagram showing a discharge lamp lighting apparatus according to related art 2. An alternating voltage generator 10 includes a switch element Q2 whose ends are connected, through a current resonant capacitor Cri, in parallel with primary windings P1 to P4 of leakage transformers T4a to T4d. The leakage transformers T4a to T4d have secondary windings S1 to S4 that are connected to discharge lamps 1a to 1d, respectively. Namely, each discharge lamp is provided with a transformer. That is, the discharge lamps 1a to 1d are connected in series with leakage inductances L1 to L4, respectively, so that the discharge lamps 1a to 1d are simultaneously turned on. In principle, any number of discharge lamps can be turned on at the same time by increasing the number of transformers.

FIG. 3 is a circuit diagram showing a discharge lamp lighting apparatus according to related art 3. In a leakage transformer T5b, a leakage inductance L1, a secondary winding S1, a leakage inductance L2, and a secondary winding S2 form a series circuit whose ends are connected to a series circuit including discharge lamps 1c and 1d. In a leakage transformer T5a, a leakage inductance L3, a secondary winding S3, a leakage inductance L4, and a secondary winding S4 form a series circuit whose ends are connected to a series circuit including discharge lamps 1a and 1b. Namely, each discharge lamp is connected in series with a leakage inductance, so that the multiple discharge lamps can simultaneously be turned on. FIG. 4 is a circuit diagram showing a discharge lamp lighting apparatus according to related art 4 that resembles the related art 3 of FIG. 3. A leakage transformer T6 has four secondary windings S1 to S4, to provide four transformer outputs.

Japanese Unexamined Patent Application Publication No. 2006-127789 discloses a technique of balancing currents for a plurality of transformers.

### SUMMARY OF THE INVENTION

The related arts 1 and 2 of FIGS. 1 and 2 each have a problem of fluctuating currents passing through discharge lamps due to variation between discharge lamp impedances, changes in discharge lamp impedances caused by temperatures, or variation between capacitors.

According to the related art 3 of FIG. 3, the discharge lamps 1a and 1b and the secondary windings of the transformer T5a form a loop and the discharge lamps 1c and 1d and the secondary windings of the transformer T5b form a loop. As a result, the discharge lamps 1a and 1b receive an equal current and the discharge lamps 1c and 1d receive an equal current. However, there is a problem that the discharge lamps 1a and 1c may not receive an equal current. The related art 4 of FIG. 4 has the same problem as the related art 3.

According to the present invention, a discharge lamp lighting apparatus capable of passing an equal current to each of a plurality of discharge lamps to be turned on can be provided.

According to a first technical aspect of the present invention, provided is a discharge lamp lighting apparatus comprising (i) a plurality of discharge lamps, (ii) an alternating voltage generator configured to convert a DC voltage into an alternating voltage, and (iii) a transformer having a primary winding and a plurality of secondary windings, the primary winding being connected to an output terminal of the alternating voltage generator. The plurality of discharge lamps and the plurality of secondary windings are connected in series and included in a closed loop.

According to a second technical aspect of the present invention that is based on the first aspect, the number of the secondary windings is an even number equal to or larger than four, every two of the secondary windings being connected in series to form a secondary winding pair. Each of the secondary winding pairs has a first end connected to a first end of one of two adjacently arranged discharge lamps and a second end connected to a first end of one of other two adjacently arranged discharge lamps.

A third technical aspect of the present invention provides a discharge lamp lighting apparatus comprising an alternating voltage generator configured to convert a DC voltage into an alternating voltage, a plurality of transformers each having a primary winding connected to an output terminal of the alternating voltage generator and a plurality of secondary windings, and a plurality of discharge lamp groups corresponding to the plurality of transformers, respectively. In connection with each of the plurality of transformers, the plurality of secondary windings and all discharge lamps in the corresponding discharge lamp group are connected in series and included in a closed loop.

### BRIEF DESCRIPTION OF THE DRAWINGS

FIG. 1 is a circuit diagram showing the discharge lamp lighting apparatus of related art 1;

FIG. 2 is a circuit diagram showing the discharge lamp lighting apparatus of related art 2;

FIG. 3 is a circuit diagram showing the discharge lamp lighting apparatus of related art 3;

FIG. 4 is a circuit diagram showing the discharge lamp lighting apparatus of related art 4;

FIG. 5 is a circuit diagram showing a discharge lamp lighting apparatus according to First embodiment of the present invention;

FIG. 6 is a circuit diagram showing a discharge lamp lighting apparatus according to Second embodiment of the present invention;

FIG. 7 is a circuit diagram showing a discharge lamp lighting apparatus according to Modification of Second embodiment;

FIG. 8 is a circuit diagram showing a discharge lamp lighting apparatus according to Third embodiment of the present invention;

FIG. 9 is a circuit diagram showing a discharge lamp lighting apparatus according to Fourth embodiment of the present invention;

FIG. 10 is a circuit diagram showing a discharge lamp lighting apparatus according to Fifth embodiment of the present invention;

FIG. 11 is a circuit diagram showing a distribution of parasitic resistances of the discharge lamp lighting apparatus of Fifth embodiment;

FIG. 12 is a circuit diagram showing a discharge lamp lighting apparatus according to Sixth embodiment of the present invention;

FIG. 13 is a circuit diagram showing a discharge lamp lighting apparatus according to Seventh embodiment of the present invention; and

FIG. 14 is a circuit diagram showing a discharge lamp lighting apparatus according to Eighth embodiment of the present invention;

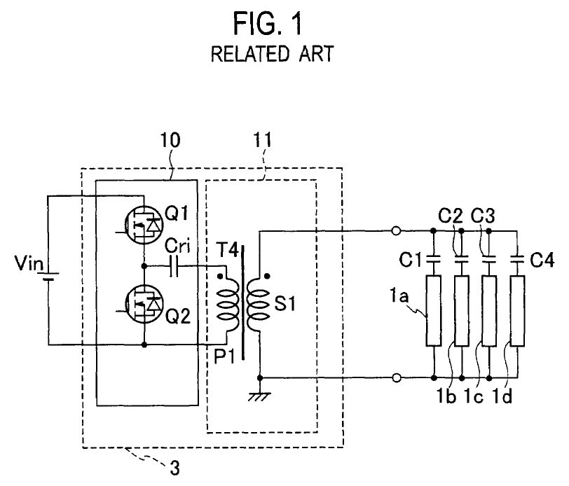

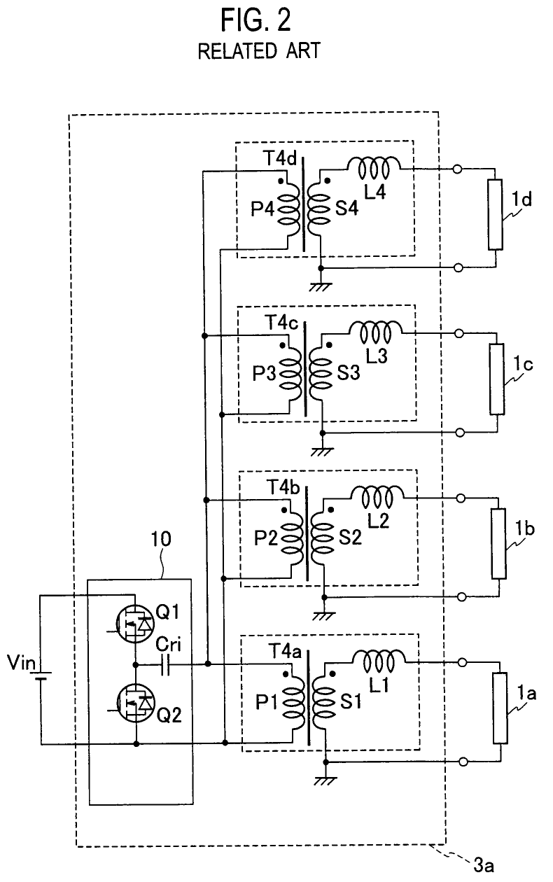

### DESCRIPTION OF THE PREFERRED EMBODIMENT

Discharge lamp lighting apparatuses according to embodiments of the present invention will be explained in detail with reference to the drawings.

### First Embodiment

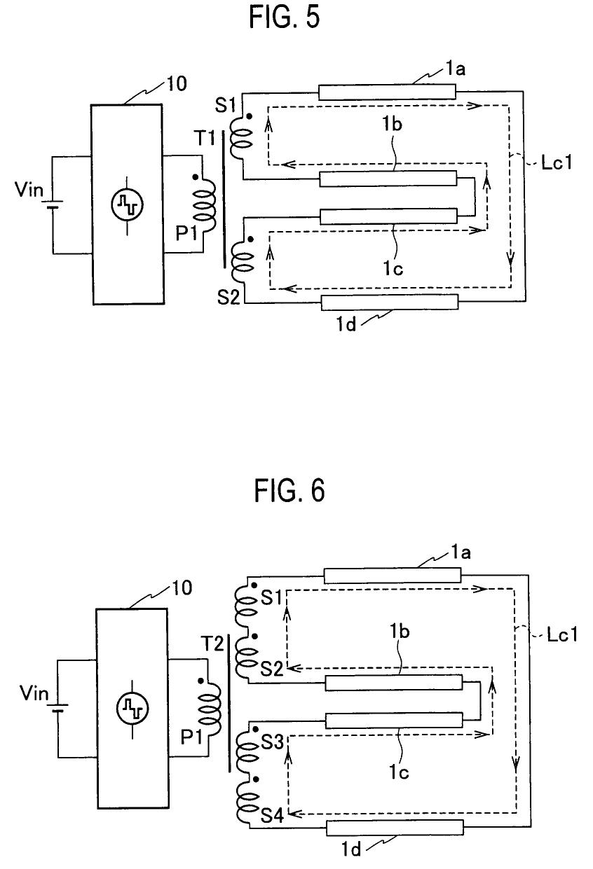

FIG. 5 is a circuit diagram showing a discharge lamp lighting apparatus according to the First embodiment of the present invention. In FIG. 5, an alternating voltage generator 10 converts a DC voltage Vin from a DC power source into an alternating voltage having a converted frequency. A transformer T1 converts the alternating voltage into one having a required voltage value. The transformer T1 has a primary winding P1 and secondary windings S1 and S2.

A first end (marked with a dot) of the secondary winding S1 of the transformer T1 is connected to a first end of a discharge lamp (first discharge lamp) 1a. A second end of the secondary winding S1 is connected to a first end of a discharge lamp (second discharge lamp) 1b. A first end (marked with a dot) of the secondary winding S2 of the transformer T1 is connected to a first end of a discharge lamp (first discharge lamp) 1c and a second end of the secondary winding S2 is connected to a first end of a discharge lamp (second discharge lamp) 1d. A second end of the discharge lamp 1b is connected to a second end of the discharge lamp 1c. A second end of the discharge lamp 1a is connected to a second end of the discharge lamp 1d. Namely, the discharge lamps 1a to 1d and the secondary windings S1 and S2 are connected in series to form or included in a closed loop Lc1.

The discharge lamps 1a to 1d and the secondary windings S1 and S2 are arranged along the closed-loop current path Lc1. The discharge lamps 1b and 1c are arranged adjacent to each other and the discharge lamps 1a and 1d are adjacent to each other. The first end of the secondary winding S1 is connected to the first end of the discharge lamp 1a of the adjacent discharge lamps 1a and 1d. The second end of the secondary winding S1 is connected to the first end of the discharge lamp 1b of the adjacent discharge lamps 1b and 1c.

The discharge lamps 1a to 1d of the present embodiment are CCFLs and may be CCFLs, EEFLs, or any other fluorescent lamps.

With the above-mentioned configuration, a current passes through the path Lc1 extending along S1, 1a, 1d, S2, 1c, 1b, and S1 in clockwise and counterclockwise directions alternately. Namely, the current passing through the four discharge lamps 1a to 1d forms the single closed loop Lc1, so that the discharge lamps 1a to 1d may receive the current of an equal value.

According to the present embodiment, a plurality of discharge lamps and a plurality of secondary windings of a transformer are connected in series and included in a single closed loop (Lc1), to pass an equal current to the discharge lamps. Namely, no difference occurs among currents received by the discharge lamps.

### Second Embodiment

Generally, a discharge lamp needs a higher voltage as the discharge lamp becomes longer. According to the First embodiment shown in FIG. 5, each of the secondary windings S1 and S2 generates a voltage for two discharge lamps. A longer discharge lamp needs a higher voltage, and if each of the secondary windings S1 and S2 must generate a higher voltage, each winding must have a higher withstand voltage and securer reliability.

FIG. 6 is a circuit diagram showing a discharge lamp lighting apparatus according to the Second embodiment of the present invention. In FIG. 6, a transformer T2 has a primary winding P1 and four secondary windings S1 to S4.

The secondary windings S1 and S2 form a series circuit (secondary winding pair) and the secondary windings S3 and S4 form a series circuit (secondary winding pair). Between a second end of the secondary winding pair of S1 and S2 and a first end of the secondary winding pair of S3 and S4, there is connected a series circuit of discharge lamps 1b and 1c. Between a first end of the secondary winding pair of S1 and S2 and a second end of the secondary winding pair of S3 and S4, there is connected a series circuit of discharge lamps 1a and 1d. The discharge lamps 1a to 1d and secondary windings S1 to S4 are connected in series to form or included in a closed loop Lc1.

The discharge lamps 1a to 1d, the secondary winding pair of S1 and S2, and the secondary winding pair of S3 and S4 are arranged along the closed-loop current path Lc1. The discharge lamps 1a and 1d are adjacent to each other and the discharge lamps 1b and 1c are adjacent to each other. The secondary windings S1 and S2 are adjacent to each other and the secondary windings S3 and S4 are adjacent to each other. The first end of the secondary winding pair of S1 and S2 is connected to a first end of the discharge lamp 1a of the adjacent discharge lamps 1a and 1d. The second end of the secondary winding pair S1 and S2 is connected to a first end of the discharge lamp 1b of the adjacent discharge lamps 1b and 1c.

With this configuration, a current passes through the path Lc1 extending along S1, 1a, 1d, S4, S3, 1c, 1b, S2, and S1 in clockwise and counterclockwise directions alternately. Namely, each discharge lamp receives an equal current. The secondary windings S1 to S4 each generates a voltage for only one corresponding discharge lamp. This is effective in particular for a long discharge lamp that needs a high voltage.

### Modification 1 of Second Embodiment

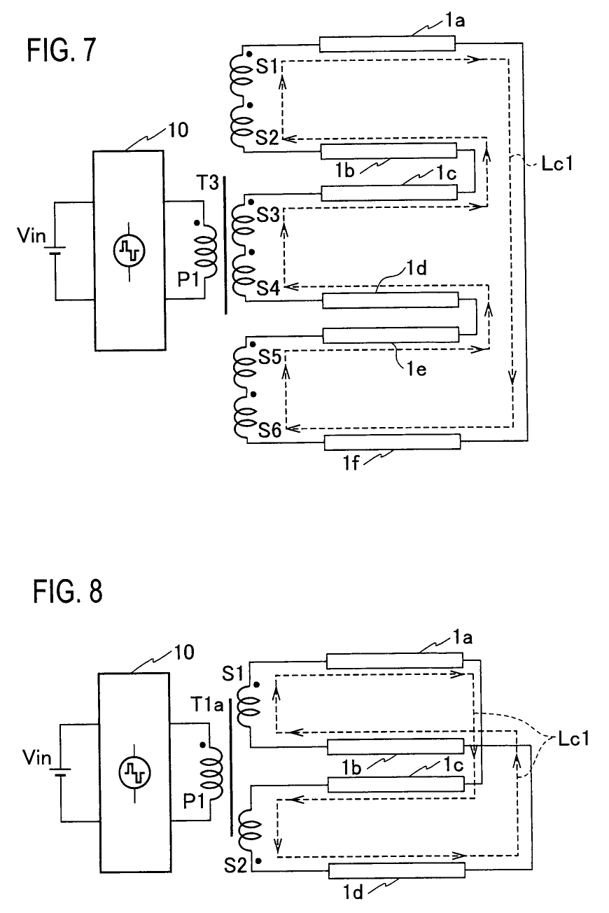

FIG. 7 is a circuit diagram showing a discharge lamp lighting apparatus according to Modification 1 of the Second embodiment. In FIG. 7, a transformer T3 has six secondary windings S1 to S6 corresponding to six discharge lamps 1a to 1f, respectively.

The discharge lamps 1a to 1f and secondary windings S1 to S6 are connected in series to form a closed Lc1, to realize the same effect as the Second embodiment. In this way, the present invention can increase the number of secondary windings of a transformer, to handle more than six discharge lamps.

### Third Embodiment

FIG. 8 is a circuit diagram showing a discharge lamp lighting apparatus according to Third embodiment of the present invention. In FIG. 8, a transformer T1a has a secondary winding S2 whose polarity is opposite to that of the First embodiment shown in FIG. 5. A second end of a discharge lamp 1a is connected to a second end of a discharge lamp 1c and a second end of a discharge lamp 1b is connected to a second end of a discharge lamp 1d.

With this configuration, a current passes through a path extending along S1, 1a, 1c, S2, 1d, 1b, and S1 in opposite directions alternately, so that each discharge lamp may receive the current of an equal value. This configuration of reversing the polarity of a transformer winding is also applicable to the Second embodiment shown in FIG. 6 and Modification 1 of the Second embodiment shown in FIG. 7.

### Fourth Embodiment

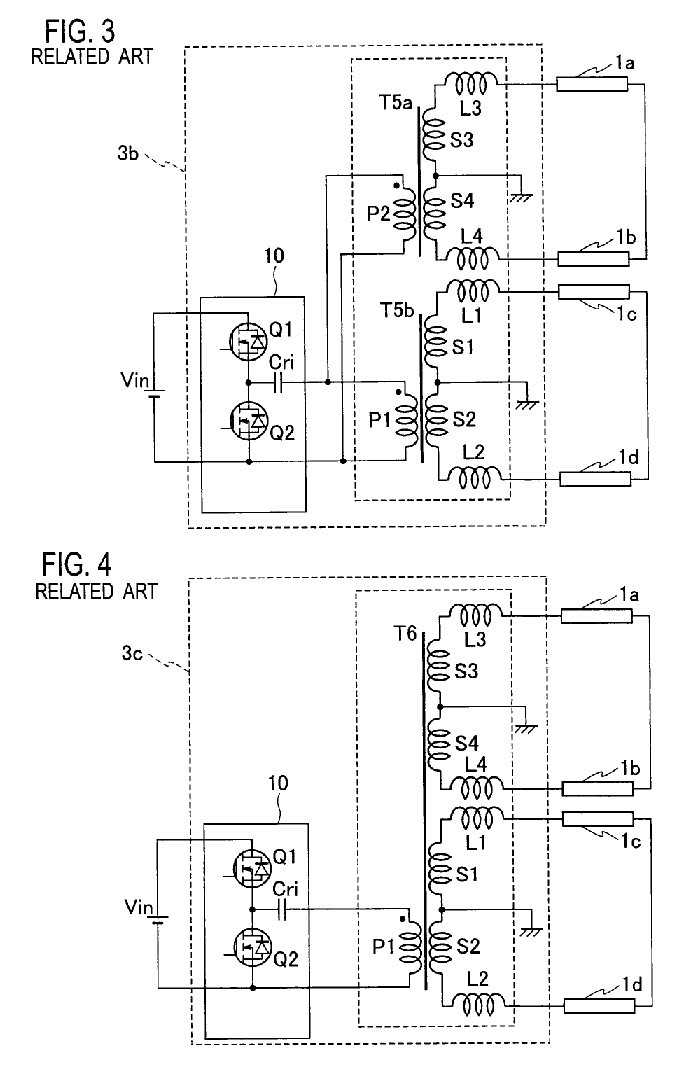

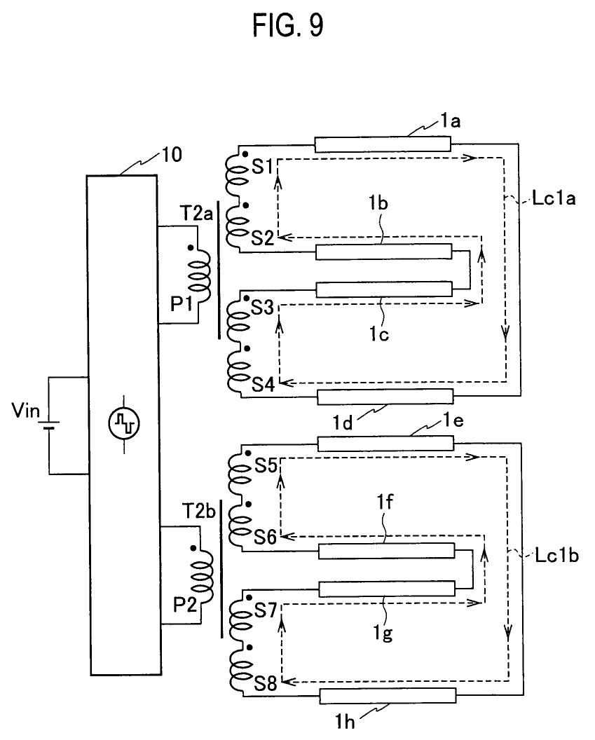

FIG. 9 is a circuit diagram showing a discharge lamp lighting apparatus according to Fourth embodiment of the present invention. In FIG. 4, two transformers T2a and T2b are used to activate eight discharge lamps.

The transformer T2a has a primary winding P1 and secondary windings S1 to S4. Four discharge lamps 1a to 1d forming a discharge lamp group and the secondary windings S1 to S4 of the transformer T2a are connected in series to form or include in a closed loop Lc1a. The transformer T2b has a primary winding P2 and secondary windings S5 to S8. Four discharge lamps 1e to 1h forming a discharge lamp group and the secondary windings S5 to S8 of the transformer T2b are connected in series to form a closed loop Lc1b.

The Fourth embodiment provides the same effect as the Second embodiment and is capable of handling eight discharge lamps 1a to 1h. The number of transformers may be increased to three, four, or more to handle a required number of discharge lamp groups.

The present embodiment is applicable to constitute a large multiple-lamp panel by arranging a plurality of transformers and a plurality of discharge lamp groups.

### Fifth Embodiment

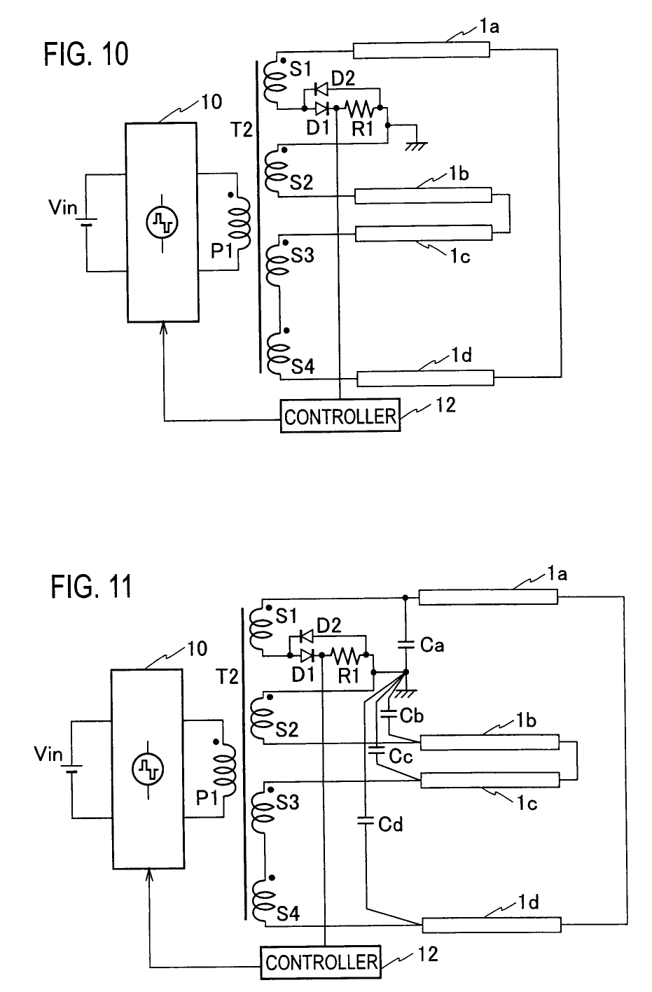

FIG. 10 is a circuit diagram showing a discharge lamp lighting apparatus according to Fifth embodiment of the present invention. In addition to the Second embodiment shown in FIG. 6, the Fifth embodiment of FIG. 10 has a current detector including diodes D1 and D2 and a resistor R1 and a controller 12.

In FIG. 10, a series circuit of the diode D1 and resistor R1 is connected between a second end of a secondary winding S1 of a transformer T2 and the ground. Ends of the series circuit are connected to the diode D2. A first end of a secondary winding S2 of the transformer T2 is grounded. A connection point of the diode D1 and resistor R1 is connected to the controller 12.

The current detector detects a current passing through the secondary winding S1. Based on the current detected by the current detector, the controller 12 controls ON/OFF of a switching element (not shown) in an alternating voltage generator 10, to pass a constant current to discharge lamps 1a to 1d. The controller 12 may detect an abnormality in the discharge lamps 1a to 1d according to the current detected by the current detector.

The present embodiment is capable of correctly detecting a current passed to each discharge lamp with the use of the current detector.

### Sixth Embodiment

Referring to FIG. 11, a distribution of parasitic capacitances of the discharge lamp lighting apparatus of FIG. 10 will be explained. In FIG. 11, there are a parasitic capacitance Ca between a first end of the discharge lamp 1a and the ground, a parasitic capacitance Cb between a first end of the discharge lamp 1b and the ground, a parasitic capacitance Cc between a first end of the discharge lamp 1c and the ground, and a parasitic capacitance Cd between a first end of the discharge lamp 1d and the ground.

Currents passing from around the secondary windings S2 to S4 to the parasitic capacitances Cb to Cd also pass through the current detecting resistor R1, and therefore, a current value detected by the current detector becomes larger than a true current value. This will deteriorate a current detecting accuracy below a specified level.

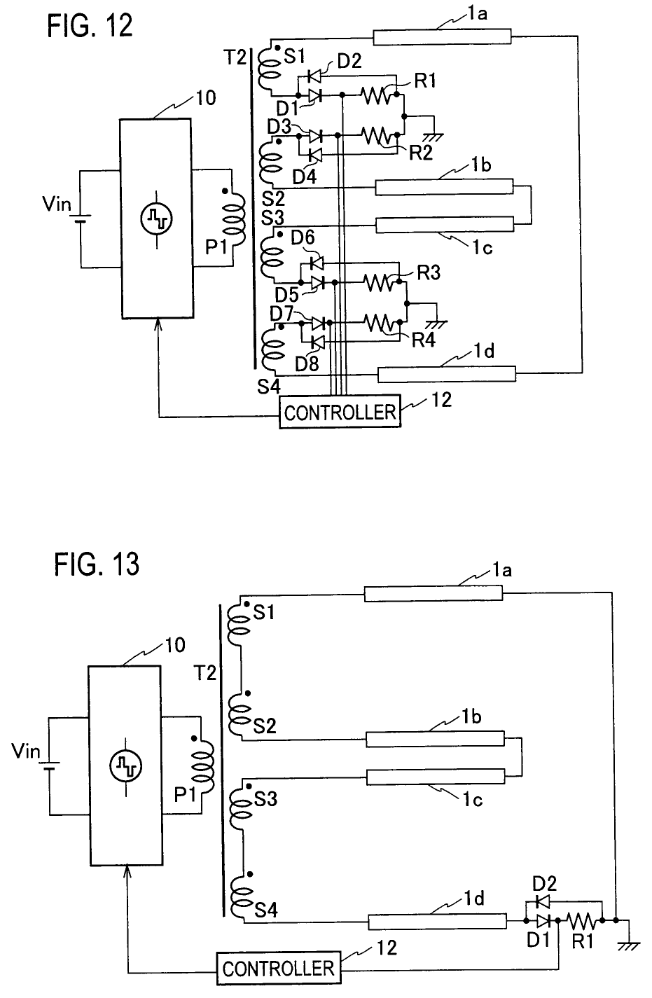

To cope with this problem, Sixth embodiment provides a discharge lamp lighting apparatus shown in FIG. 12 that is capable of realizing an improved current detecting accuracy. In FIG. 12, each secondary winding of a transformer T2 is provided with a current detector. Namely, a second end of the secondary winding S1 is connected to a current detector having diodes D1 and D2 and a resistor R1 connected in series to detect a current passing through the secondary winding S1. A first end of the secondary winding S2 is connected to a current detector having diodes D3 and D4 and a resistor R2 connected in series to detect a current passing through the secondary winding S2. A second end of the secondary winding S3 is connected to a current detector having diodes D5 and D6 and a resistor R3 connected in series to detect a current passing through the secondary winding S3. A first end of the secondary winding S4 is connected to a current detector having diodes D7 and D8 and a resistor R4 to detect a current passing through the secondary winding S4. A controller 12 totals the current values detected by the current detectors, finds an average thereof, and according to the average, controls an alternating voltage generator 10 to pass a constant current to the discharge lamps 1a to 1d. This configuration improves a current detecting accuracy.

### Seventh Embodiment

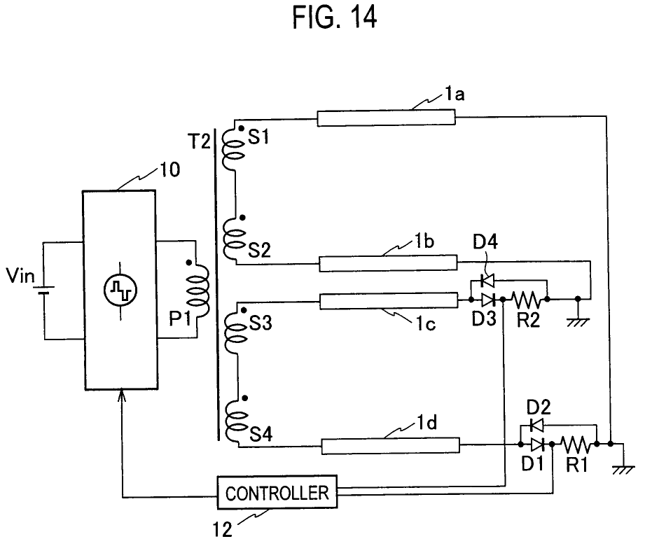

FIG. 13 is a circuit diagram showing a discharge lamp lighting apparatus according to Seventh embodiment of the present invention. In addition to the Second embodiment shown in FIG. 6, the Seventh embodiment shown in FIG. 13 employs a current detector including diodes D1 and D2 and a resistor R1 and a controller 12.

In FIG. 13, a transformer T2 has a secondary winding S1 whose first end is connected to a discharge lamp 1a whose second end is grounded. A secondary winding S4 of the transformer T2 has a second end connected to a discharge lamp 1d. Between a second end of the discharge lamp 1d and the ground, there is connected a series circuit of the diode D1 and resistor R1. Ends of the series circuit are connected to the diode D2. A connection point of the diode D1 and resistor R1 is connected to the controller 12.

The current detector detects a current to the secondary winding S4. Based on the current detected by the current detector, the controller 12 controls ON/OFF of a switching element (not shown) in an alternating voltage generator 10, to pass a constant current to the discharge lamps 1a to 1d. The controller 12 may detect an abnormality in the discharge lamps 1a to 1d according to the current detected by the current detector.

### Eighth Embodiment

FIG. 14 is a circuit diagram showing a discharge lamp lighting apparatus according to Eighth embodiment of the present invention. In addition to the Seventh embodiment shown in FIG. 13, the Eighth embodiment of FIG. 14 employs a current detector including diodes D3 and D4 and a resistor R2.

In FIG. 14, a transformer T2 has a secondary winding S2 whose second end is connected to a discharge lamp 1b whose second end is grounded. A secondary winding S3 of the transformer T2 has a first end connected to a discharge lamp 1c. Between a second end of the discharge lamp 1c and the ground, there is connected a series circuit including the diode D3 and resistor R2. Ends of the series circuit are connected to the diode D4. A connection point of the diode D3 and resistor R2 is connected to a controller 12.

The controller 12 sums up current values detected by the current detectors, finds an average thereof, and according to the average, controls an alternating voltage generator 10 to pass a constant current to the discharge lamps 1a to 1d. This configuration improves a current detecting accuracy. The controller 12 may detect an abnormality in the discharge lamps 1a to 1d according to the currents detected by the current detectors.

This application claims benefit of priority under 35 USC §119 to Japanese Patent Applications No. 2007-206641, filed on Aug. 8, 2007, the entire contents of which are incorporated by reference herein. Although the invention has been described above by reference to certain embodiments of the invention, the invention is not limited to the embodiments described above. Modifications and variations of the embodiments described above will occur to those skilled in the art, in light of the teachings. The scope of the invention is defined with reference to the following claims.

What is claimed is:

1. A discharge lamp lighting apparatus comprising:
a plurality of discharge lamps;
an alternating voltage generator configured to convert a DC voltage into an alternating voltage; and
a transformer having a primary winding and a plurality of secondary windings, the primary winding being connected to an output terminal of the alternating voltage generator, wherein
the plurality of discharge lamps and the plurality of secondary windings are connected in series and included in a closed loop.

2. The discharge lamp lighting apparatus according to claim 1, wherein each of the plurality of secondary windings having:
a first end connected to a first end of one of two adjacently arranged discharge lamps; and
a second end connected to a first end of another of the two adjacently arranged discharge lamps.

3. The discharge lamp lighting apparatus according to claim 1, wherein
the number of the secondary windings is an even number equal to or larger than four, and every two of the secondary windings being connected in series to form a secondary winding pair; and
each of the secondary winding pairs having:
a first end connected to a first end of one of two adjacently arranged discharge lamps; and
a second end connected to a first end of another of the two adjacently arranged discharge lamps.

4. The discharge lamp lighting apparatus according to claim 3, wherein:
one secondary winding of one secondary winding pair among the plurality of secondary winding pairs has an end being connected to a grounding; and
a current detector is arranged between an end of the other secondary winding of the secondary winding pair and the grounding.

5. The discharge lamp lighting apparatus of claim 3, wherein:
a secondary winding of one secondary winding pair in two adjacent secondary winding pairs among the plurality of secondary winding pairs has an end connected to a first end of a discharge lamp whose second end is connected to a grounding; and
a current detector is arranged between the grounding and a second end of a discharge lamp whose first end is connected to a secondary winding of the other secondary winding pair in the two adjacent secondary winding pairs.

6. A discharge lamp lighting apparatus comprising:
an alternating voltage generator configured to convert a DC voltage into an alternating voltage;
a plurality of transformers each having a primary winding connected to an output terminal of the alternating voltage generator and a plurality of secondary windings; and
a plurality of discharge lamp groups corresponding to the plurality of transformers, respectively, wherein
in connection with each of the plurality of transformers, the plurality of secondary windings and all discharge lamps in the corresponding discharge lamp group are connected in series and included in a closed loop.
